(19) United States
(12) Patent Application Publication
(10) Pub. No.: US 2026/0187520 A1
(43) Pub. Date: Jul. 2, 2026

(54) TRAINING A MACHINE LEARNED MODEL BASED ON A TRAINING VECTOR ASSOCIATED WITH A TEXT DOCUMENT EMBEDDING AND AN ATTRIBUTE SET

(71) Applicant: Optum, Inc., Minnetonka, MN (US)

(72) Inventors: Natalie Jean Lambert, Brownsburg, IN (US); Joel David Stremmel, Iowa City, IA (US); Eran Halperin, Santa Monica, CA (US); Kimmo M. Karkkainen, Santa Monica, CA (US); Vijay S. Nori, Roswell, GA (US); Kelsey Marie Chabal, Richmond, VA (US)

(21) Appl. No.: 19/003,030

(22) Filed: Dec. 27, 2024

(51) Int. Cl. G06N 20/00

(52) U.S. Cl. CPC G06N 20/00

(57) ABSTRACT

Various embodiments of the present disclosure provide for training and/or deploying a machine learned model based on a training vector associated with a text document embedding and an attribute set. The techniques may include receiving a user attribute feature set associated with a user identifier for a user-text pair, generating an input text document embedding for the user identifier, generating an input vector by concatenating the user attribute feature set with the input text document embedding, generating, using a machine learned model that is trained based on a ground truth label and a training vector associated with a text document embedding generated by a text encoder model, a classification score for the input text document embedding based on the input vector, and generating a transcript corresponding to the input text document embedding upon determining that the classification score satisfies a predetermined threshold.

### BACKGROUND

Various embodiments of the present disclosure address technical challenges related to training machine learned models and/or performing machine learning data analysis in a computationally accurate, efficient, and/or consistent manner. Existing machine learning techniques are ill-suited to accurately, efficiently, and/or consistently perform predictive data analysis in various domains, such as domains that are associated with high-dimensional categorical feature spaces with a high degree of cardinality.

Various embodiments of the present disclosure make important contributions to traditional machine learned models and machine learning techniques by addressing these technical challenges, among others.

### BRIEF DESCRIPTION OF THE DRAWINGS

FIG. 1 provides an example overview of an architecture in accordance with one or more embodiments of the present disclosure.

FIG. 2 provides an example predictive data analysis computing entity in accordance with some embodiments of the present disclosure.

FIG. 3 provides an example client computing entity in accordance with one or more embodiments of the present disclosure.

FIG. 4 is a dataflow diagram showing example data structures, modules, and/or pipelines for generating a training data object in accordance with one or more embodiments discussed herein.

FIG. 5 is a dataflow diagram showing example data structures, modules, and/or pipelines for training a machine learned model in accordance with one or more embodiments discussed herein.

FIG. 6 is a dataflow diagram showing example data structures, modules, and/or pipelines for generating a feature set in accordance with one or more embodiments discussed herein.

FIG. 7 is a dataflow diagram showing example data structures, modules, and/or pipelines for deploying a machine learned model in accordance with one or more embodiments discussed herein.

FIG. 8 provides an example system for providing prediction-based actions and/or visualizations in accordance with one or more embodiments discussed herein.

FIG. 9 provides an example user interface in accordance with one or more embodiments discussed herein.

FIG. 10 is a flowchart diagram of an example process for training and/or deploying a machine learned model based on a training vector associated with a text document embedding and an attribute set in accordance with one or more embodiments discussed herein.

FIG. 11 is a flowchart diagram of an example process for training and/or deploying a machine learned model in accordance with one or more embodiments discussed herein.

### DETAILED DESCRIPTION

Various embodiments of the present disclosure provide data processing and/or machine learning techniques that improve upon traditional data processing engines and/or traditional data processing techniques. To do so, some embodiments of the present disclosure provide a training pipeline for a machine learned model that utilizes encoder-based machine learning to generate a text document embedding of a text-based prompt. The training pipeline additionally or alternatively generates a training vector for the machine learned model by mapping the text document embedding to a user attribute dataset. Additionally or alternatively, the training pipeline trains the machine learned model based on the training vector. In some embodiments, the training vector is included in an optimized training dataset for the machine learned model. This, in turn, enables an improved machine learned model that is computationally accurate, efficient, and/or optimally tuned for subjective classification tasks related to text-based prompts.

In some embodiments of the present disclosure, an inference pipeline for the trained machine learned model is additionally or alternatively provided. Due to the improved training and/or optimized training dataset for the machine learned model, weights and/or parameters of the trained machine learned model may be tuned in an optimal manner to provide improved prediction-based actions for a prediction domain while also minimizing a number of computing resources and/or power consumption during execution of the machine learned model. In some embodiments of the present disclosure, a retraining pipeline for the trained machine learned model is provided to further tune weights and/or parameters of the trained machine learned model according to real-time output and/or optimization criteria for the trained machine learned model. This, in turn, enables an improved machine learning pipeline that directly addresses technical challenges within the realm of traditional machine learning techniques, such as inaccurate formatting of a training dataset for a machine learned model, time-consuming ingestion of a training dataset for a machine learned model, resource intensive transformation of data for a machine learned model, and/or inaccurate datasets for machine learning tasks, among others.

In some embodiments of the present disclosure, data may be intelligently formatted for a particular data processing task such as, for example, a machine learning task or an API task for an electronic interface. In some embodiments, data provided by a trained machine learned model may be configured with improved quality for one or more downstream systems associated with one or more data processing tasks.

To ensure a uniform and/or properly formatted training dataset for one or more machine learning training tasks, some embodiments of the present disclosure provide data preprocessing for a machine learned model to directly tailor formatting, cleansing, and/or task-specific requirements for a training dataset. As described herein, the specific data processing and/or machine learning techniques leveraged for generating an optimized training dataset enable a machine learned model to perform a particular computing task that is traditionally unachievable and/or error prone using traditional machine learning techniques.

The machine learning disclosed can also provide significant advantages over existing technological solutions, such as, improved integrability, reduced complexity, improved accuracy, and/or improved speed as compared to existing technological solutions for providing insights and/or forecasts related to data. Accordingly, by employing various techniques related to the machine learning training and/or inference framework disclosed herein, various embodiments of the present disclosure enable utilizing efficient and reliable machine learning solutions to process data feature spaces with a high degree of size, diversity and/or cardinality. In doing so, various embodiments of the present disclosure address shortcomings of existing system solutions and enable solutions that are capable of accurately, efficiently and/or reliably providing predictions, recommendations, forecasts, insights, and classifications to facilitate optimal decisions and/or actions related to text-based prompts and/or associated scripts. Moreover, by employing various techniques related to the machine learning training and/or inference framework disclosed herein, one or more other technical benefits can be provided, including improved interoperability, improved reasoning, reduced errors, improved information/data mining, improved analytics, and/or the like related to machine learning. Accordingly, the machine learning training and/or inference framework disclosed herein provides improved predictive accuracy for recommendations related to text-based prompts without reducing training speed and also enable improving training speed given a constant predictive accuracy. In doing so, the techniques described herein can additionally or alternatively improve efficiency and speed of training machine learned models, thus reducing the number of computational operations needed and/or the amount of training data entries needed to train machine learned models. Accordingly, the techniques described herein improve at least one of the computational efficiency, storage-wise efficiency, and speed of training machine learned models.

Examples of technologically advantageous embodiments of the present disclosure include: (i) data processing techniques such as, for example, data pre-processing techniques for improving a training dataset for a machine learned model, (ii) machine learning techniques for optimizing a text-based prompt for a downstream data processing task, (iii) improved machine learned models, and training techniques thereof, for mapping data elements of a text-based prompt and/or a user attribute dataset into a training vector for a machine learned model, (iv) and improved user interfaces for receiving output provided by machine learned models, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

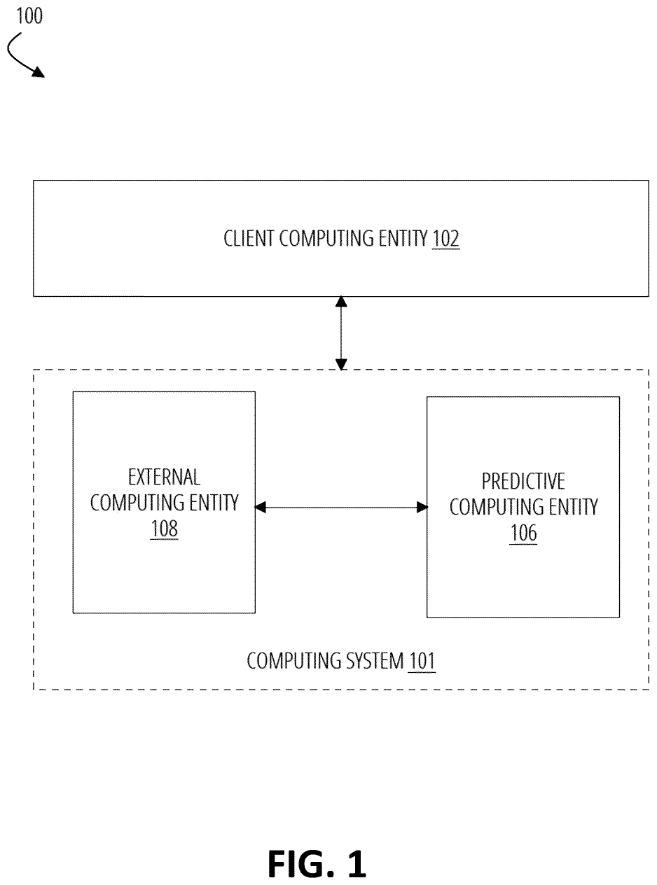

FIG. 1 depicts an example overview of an architecture 100 in accordance with some embodiments of the present disclosure. The architecture 100 comprises a computing system 101 configured to receive a request, such as a user interface request, a computing tasks request, a machine learning request, a model prompt request, a query, and/or the like, from client computing entities 102, process the request, and provide one or more responses, such as model output, machine learning output, a data visualization, a user interface overlay, one or more graphical elements, and/or the like to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a differential request handling engine and/or complementary scoring mechanism that may collectively process a request using data scaling and/or data pre-processing. Some techniques of the present disclosure may adapt traditional models to a cohesive modeling framework for more efficiently handling portions of the request handling process.

In some embodiments, the computing system 101 communicates with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate multi-level regression models in accordance with one or more training and/or inference operations of the present disclosure. In some examples, the external computing entities 108 may be configured to train, implement, use, update, and evaluate multi-level regression models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, multi-level regression modeling techniques scoring techniques, etc.) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as one or more recorded entity cohorts and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained model trained and subsequently provided by the one or more external computing entities 108. For example, the one or more external computing entities 108 may be configured to perform one or more training steps/operations of the present disclosure to train a model, as described herein. In such a case, the trained model may be provided to the predictive computing entity 106, which may leverage the trained model to perform one or more inference steps/operations of the present disclosure. In some examples, feedback (e.g., evaluation data, ground truth data) from the use of the model may be received and/or stored by the predictive computing entity 106. In some examples, the feedback may be provided to the one or more external computing entities 108 to continuously train the model over time. In some examples, the feedback may be leveraged by the predictive computing entity 106 to continuously train the model over time. In this manner, the computing system 101 may perform, via one or more combinations of computing entities, one or more prediction, training, and/or any other modeling techniques of the present disclosure.

### A. Example Predictive Computing Entity

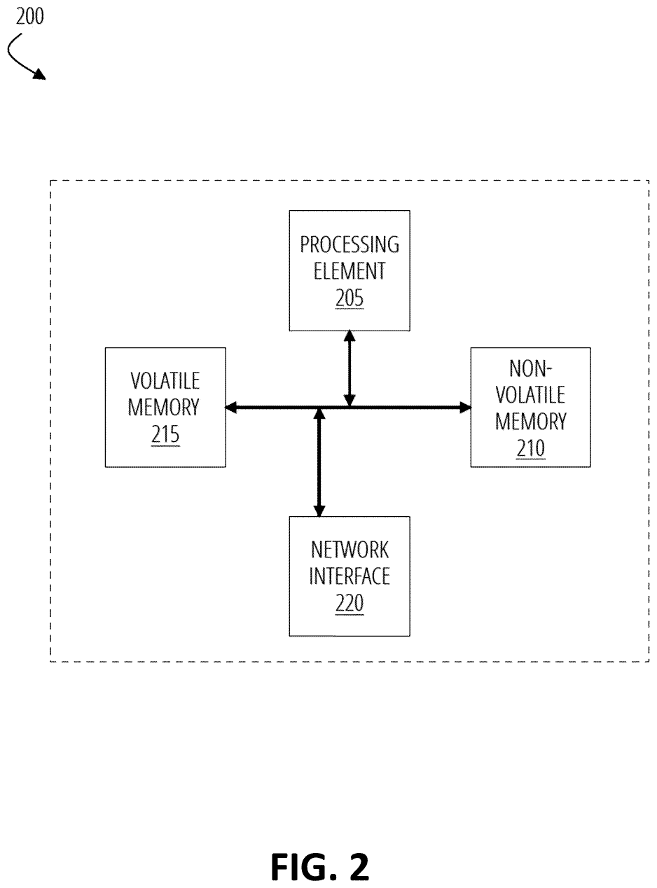

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may in addition or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may in addition or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

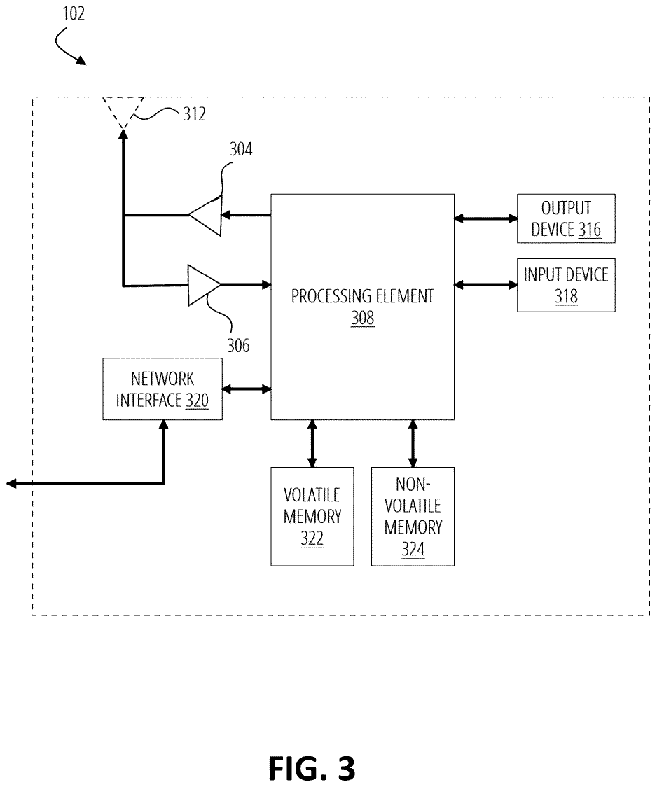

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may in addition or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may in addition or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to data processing and/or machine learning techniques. In particular, systems and methods are disclosed herein that implement training and/or inference techniques associated with machine learning to improve training and/or performance of a machine learned model for a particular predictive task and/or a particular generative task. By doing so, quality of data objects for particular computing tasks and/or particular user interface tasks that utilize the machine learned model may be further improved to expand the applicability of machine learning techniques to task-specific use cases. In some embodiments, the use of machine learned model may be configured for optimized machine learning and/or optimized data processing that is traditionally outside the scope of such models therefore resulting in an improvement to machine learning that is practically applied herein to address technical challenges with tradition machine learning. In some embodiments, the use of the machine learned model may be configured to improve data provided to one or more downstream machine learned models, a machine learned model deployment pipeline, a user interface pipeline, a communication channel pipeline, a messaging pipeline, a networking pipeline, and/or other downstream data processing.

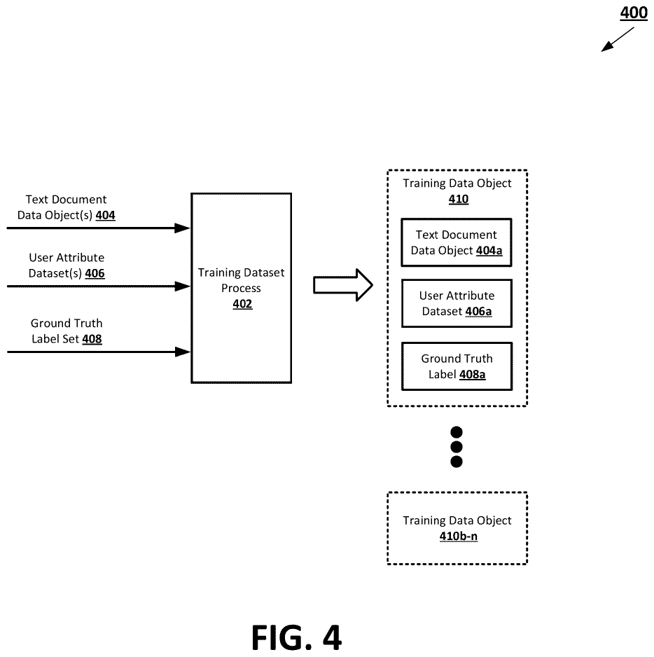

FIG. 4 is a dataflow diagram 400 showing example data structures, modules, and/or pipelines for generating a training data object in accordance with some embodiments discussed herein. In some embodiments, the dataflow diagram 400 provides a training stage that utilizes data related to one or more text-based prompt for generating a training dataset for a machine learned model. The dataflow diagram 400 includes a training dataset process 402. In various embodiments, the predictive computing entity 106 may perform the training dataset process 402. The training dataset process 402 may process one or more training text-based prompts 404, one or more user attribute datasets 406, and/or a ground truth label set 408 to generate a training data object 410. In some embodiments, the training dataset process 402 may generate the training data object 410 for utilization via one or more other training stages associated with a machine learned model.

In some embodiments, a training data object 410 is generated based on a user-text pair. The training data object 410, for example, may include a ground truth label 408a from a ground truth label set 408, a user attribute dataset 406a that corresponds to a user identifier of the user-text pair, and a training text-based prompt 404a that corresponds to the user-text pair. The user attribute dataset 406a may be received from one or more user attribute datasets 406 based on the user identifier of the user-text pair. The training text-based prompt 404a may be received from one or more training text-based prompts 404 based on the text-based prompt identifier of the user-text pair. In some examples, the training text-based prompt 404a may include a first branching script that is generated before a machine learned model is trained.

A machine learned model may be a hardware and/or software architecture having one or more parameters (e.g., coefficient(s), weight(s), biase(s), activation function(s) and/or action function type(s) in examples where the activation function and/or function type is determined as part of training, clustering centroid(s)/medoid(s), partition(s)) determined as a result of training the machine-learned model based at least in part on training hyperparameters and/or structural hyperparameters defining the model's architecture. In some examples, structural hyperparameter(s) may define component(s) of the model's architecture and/or their configuration/order, such as, for example, the configuration/order specifying which output(s) of one component are provided as input to other component(s); a number, type, and/or configuration of component(s) per layer, a number of layers of the model, a number of input nodes in an input layer of the model, a number of output nodes of an output layer of the model, component dimension (e.g., input size versus output size), temperature, and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., embedding model(s), generative pre-trained transformer(s) (GPT(s))), neural network(s), multi-layer perceptron(s), Kolmogorov-Arnold network(s), clustering algorithm(s), support vector machine(s), etc.

Additional or alternate hyperparameter(s) (i.e., training hyperparameter(s)) may be used as part of training the machine-learned model. In some examples, the training hyperparameter(s), in addition to the training data and/or input data, may affect determining the parameter(s) of the machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate optimization algorithm type (e.g., gradient descent, adaptive, stochastic) used to determine an alteration to one or more parameters of one or more components of the machine-learned model to reduce the loss determined by the loss function, and/or the like. In some examples, the structural hyperparameters and/or the training hyperparameters may be determined by a hyperparameter optimization algorithm or based on user input, such as a software component written by a user or generated by a machine-learned model. The machine learned model may include any type of model configured, trained, and/or the like to generate a classification score for a model input. The machine learned model may include one or more of any type of machine learned model including one or more supervised, unsupervised, semi-supervised, and/or reinforcement learning models. In some embodiments, the machine learned model may include a single machine-learned model or multiple machine-learned model models configured to perform one or more different stages of a prediction process.

In some embodiments, a machine learned model is a supervised machine learned model that is pre-trained using one or more supervisory and/or semi-supervised training techniques, such as backpropagation of errors, and/or the like. A machine learned model may be trained using the training dataset that includes a set of training data objects associated with one or more training text-based prompts. In some examples, the labels may comprise partition(s), centroid(s) indicated by a user, class(es), k for use in supervised clustering algorithm training, a ground truth value, a ground truth classification, and/or the like. In an example where the machine-learned model is a semi-supervised machine-learned model, the training dataset may comprise previous input(s) to and/or previous output(s) generated by the machine-learned model or another machine-learned model. The machine learned model may be trained based at least in part on providing a first training input of the set of training inputs to the machine-learned model, determining an output by the machine-learned model, determining a difference between the output and a first training output of the set of training outputs, determining a loss by a loss function based at least in part on the difference, and altering one or more parameters of the machine learned model to reduce the loss (e.g., using a loss optimization algorithm, such as gradient descent). In some examples, this process may be iteratively repeated for up to all of the inputs of the set of training inputs, respectively.

A ground truth label may be a training label for a machine learned model. A ground truth label, for example, may include a ground-truth binary label, a ground-truth classification, a ground-truth text classification, a ground-truth numerical classification, a ground-truth categorical classification, and/or the like. In some embodiments, a ground truth label may include one or more attributes and/or features for a respective label. In some embodiments, a ground truth label may be utilized for training (e.g., via a training pipeline) of a machine learned model. In some embodiments, a ground truth label may correspond to a ground-truth engagement label associated with a type of engagement between a respective user identifier and a respective text-based prompt. For example, a ground truth label may correspond to a user-text pair associated with a particular type of engagement that is realized between a user identifier and a text-based prompt presented to the user identifier via a user interface and/or user device. The type of engagement, for example, may identify a positive engagement (“1”) and/or a negative engagement (“0”).

In some embodiments, a text-based prompt is a data entity that describes textual prompt and/or semantic metadata for the prompt. A text-based prompt, for example, may include a script for interacting with a user. In some examples, the script may include a branching script with one or more decision points. At each decision point, the script may include one or more different text segments depending on an interaction from a user. In this manner, a text-prompt may form an interactive sequence of text segments for adaptively interacting with a user. In some examples, the semantic metadata may include one or more instructions for controlling a provision of the one or more text segments to a user. The one or more instructions, for example, may describe a tone, purpose, cue, voice tones, context, and/or other instructions for controlling a form in which the one or more text segments are provided to a user. By way of example, a script may include an interactive script that allows a user to interact with the script via a user interface, data visualization, and/or a web application. For example, a script may be executed in real-time and/or in a dynamic manner based on user interactions with respect to a user interface, data visualization, and/or a web application.

A text-based prompt may include different types of text segments depending on a particular domain. For example, in a clinical domain, text segments may include clinically relevant information for informing a user with respect to their healthcare plan, one or more medical terminologies (e.g., International Classification of Diseases (ICD) codes, Current Procedural Terminology (CPT) codes, and/or the like), and/or the like. In other examples, the text segments may include customer service scripts for a customer service domain, technical assistance scripts for a software services domain, and/or the like.

In some embodiments, a text-based prompt is one of a plurality of candidate text-based prompts with varying degrees of effectiveness for a particular user. Due to the subjective nature of prompting a user, measuring the effectiveness of text-based prompts, such as by using machine learning techniques, is a traditionally compute intensive task that lacks predictive accuracy. This accuracy is further reduced for new text-based prompts that are created after a machine learned model is trained. For example, a traditional machine learned model may be trained using a plurality of training text-based prompts 404 to optimize the performance of the machine learned model with respect to the plurality of training text-based prompts 404. By doing so, the machine learned model may be configured to perform well with predictions regarding input text-based prompts selected from the plurality of training text-based prompts 404 but may lack accuracy with respect to new input text-based prompts that are not included in the plurality of training text-based prompts 404.

In some embodiments of the present disclosure, a machine learned model is trained, using a plurality of training text-based prompts 404, to generate a classification score for an input text-based prompt. In some examples, the training text-based prompts 404 may include an initial set of seed scripts and input text-based prompts that may include new and/or modified scripts that are adaptively created over time to handle new scenarios within a particular domain. In some examples, a script and/or a new script may be generated based on a behavioral science simulations, and/or the like. In some examples, a plurality of training text-based prompts 404 may be used as a basis for a training dataset that includes the training data object 410. The training dataset may be a data structure that includes one or more training data objects for a machine learned model. The training dataset may include any type (and any number) of data storage structures including, as examples, one or more linked lists, databases (e.g., relational databases, graph database, etc.), and/or the like. In some examples, the training dataset may include a labelled dataset for training of the machine learned model. The labelled dataset may include a plurality of training data objects that each include a label (e.g., ground truth) and training input (and/or data to derive a training input).

In some embodiments, the training dataset process 402 may aggregate, combine, format, and/or transform one or more portions of the one or more training text-based prompts 404, the one or more user attribute datasets 406, and/or the ground truth label set 408 to generate a plurality of training data objects 410 of a training dataset. For example, the training data object 410 may include a training text-based prompt 404a of the training text-based prompts 404, a user attribute dataset 406a of the one or more user attribute datasets 406, and/or a ground truth label 408a of the ground truth label set 408. In some embodiments, the training dataset process 402 may additionally generate one or more other training data objects 410b-n that includes another training text-based prompt of the one or more training text-based prompts 404, another attribute dataset of the one or more user attribute datasets 406, and/or another ground truth label of the ground truth label set 408. In some embodiments, the training data object 410 and/or the one or more training data objects 410b-n may be a training data set for a machine learned model.

A training data object may be a data entity of a training dataset. A training data object, for example, may include a labelled training entry for training a machine learned model. In some examples, a training data object may be defined to improve a prediction with respect to the efficacy of a training text-based prompt for a particular user. To do so, each training data object may correspond to a user-text pair that identifies a particular combination of text-based prompt and user. The user-text pair, for example, may include text-based prompt identifier (e.g., a unique code corresponding to a text-based prompt) and a user identifier (e.g., a unique code corresponding to a user). In some examples, a training data object may be generated based on the user-text pair. For instance, a training data object may be generated by receiving a training text-based prompt that corresponds to the text-based prompt identifier and receiving a user attribute dataset that corresponds to the user identifier. In addition, or alternatively, the training data object may include a ground truth label for the user-text pair that corresponds to a type of engagement between the user and the training text-based prompt.

In some embodiments, the training dataset is a data structure that includes one or more training data objects 410 for a machine learned model. A training dataset may include any type (and any number) of data storage structures including, as examples, one or more linked lists, databases (e.g., relational databases, graph database, etc.), and/or the like. In some examples, the training dataset may include a labelled dataset for training of the machine learned model. The labelled dataset may include a plurality of training data objects 410 that each include a label (e.g., ground truth label 408a) and training input (and/or data to derive a training input).

In some embodiments, the training data object 410 is a data entity of a training dataset. A training data object 410, for example, may include a labelled training entry for training a machine learned model. In some examples, a training data object 410 may be defined to improve a prediction with respect to the efficacy of a training text-based prompt for a particular user. To do so, each training data object 410 may correspond to a user-text pair that identifies a particular combination of text-based prompt and user. The user-text pair, for example, may include text-based prompt identifier (e.g., a unique code corresponding to a text-based prompt) and a user identifier (e.g., a unique code corresponding to a user). In some examples, a training data object 410 may be generated based on the user-text pair. For instance, a training data object 410 may be generated by receiving a training text-based prompt 404a that corresponds to the text-based prompt identifier and receiving a user attribute dataset 406a that corresponds to the user identifier. In addition, or alternatively, the training data object 410 may include a ground truth label 408a for the user-text pair that corresponds to a type of engagement between the user and the training text-based prompt 404a.

In some embodiments, the user attribute dataset 406a is a collection of data constructs that describes attributes and/or features for a user identifier. In some embodiments, one or more portions of a user attribute dataset 406a may be obtained from a user profile and/or a user data datastore. A user identifier may be a data entity that identifies a user associated with user data. In some embodiments, a user identifier may be associated with a user device. For example, in some embodiments, a user identifier may be associated with user device information, user device location information, network address information, information included in a network data packet transmitted by a user device, and/or other information associated with a user device. In some embodiments, a user identifier may be a patient identifier or a member identifier. In an example, a user attribute dataset may include one or more attributes such as, but not limited to, historical user behavior, historical medication behavior, census data, historical interaction patterns, domain attributes for a particular domain, and/or other user data.

In some embodiments, census data includes one or more demographics attributes such as, but not limited to, location attributes, age attributes, gender attributes, and/or other demographic attributes. In some embodiments, demographics attributes may include attributes associated with a particular geographic location (e.g., zip-code level) based on demographic indicators, socioeconomic indicators, risk flags (e.g., geographic level of scoring using historical credit and/or payment behavior), estimated household debt, net worth indicators, dual income information, short term loan indexes, and/or other socio-demographic information at a particular geographic location.

In some embodiments, domain attributes may be clinical attributes for a clinical domain. In some embodiments, domain attributes correspond to attributes and/or features for a healthcare plan. In some embodiments, one or more portions of the domain attributes may be obtained from a domain knowledge profile and/or a domain knowledge datastore. In an example, the domain attributes may include one or more attributes related to member costs for a healthcare plan, a plan type indicator, plan costs, doctor visits, provider information, plan ratings, attributes related to medical benefits, attributes related to prescription drugs, attributes related to additional benefits, attributes related to dental coverage, and/or other domain attributes. In some embodiments, attributes related to medical benefits can include, but is not limited to, outpatient services, inpatient services, hospital services, mental health services, treatment program services, home health services, annual wellness visits, skilled nursing facilities, ground ambulance services, emergency services, annual routine physical exams, diabetic monitoring supplies, procedures information, x-ray information, lab services, diagnostic procedures/tests, diabetes screening, diagnostic radiological services, air ambulance services, ambulatory surgical services, urgent care, hearing exams, hearing aids, eyewear, eye exams, fitness, meal benefits, medical telehealth, footcare, chiropractors, acupuncture, and/or medical benefits information. In some embodiments, attributes related to prescription drugs can include, but is not limited to, premiums, deductibles, initial coverage limits, thresholds, pay associated with prescription tiers, and/or other prescription drug information.

In some embodiments, the ground truth label 408a is a training label for a machine learned model. A ground truth label 408a, for example, may include a ground-truth binary label, a ground-truth classification, a ground-truth text classification, a ground-truth numerical classification, a ground-truth categorical classification, and/or the like. In some embodiments, a ground truth label 408a may include one or more attributes and/or features for a respective label. In some embodiments, a ground truth label 408a may be utilized for training (e.g., via a training pipeline) of a machine learned model. In some embodiments, a ground truth label 408a may correspond to a ground-truth engagement label associated with a type of engagement between a respective user identifier and a respective text-based prompt. For example, a ground truth label 408a may correspond to a user-text pair associated with a particular type of engagement that is realized between a user identifier and a text-based prompt presented to the user identifier via a user interface and/or user device. The type of engagement, for example, may identify a positive engagement (“1”) and/or a negative engagement (“0”).

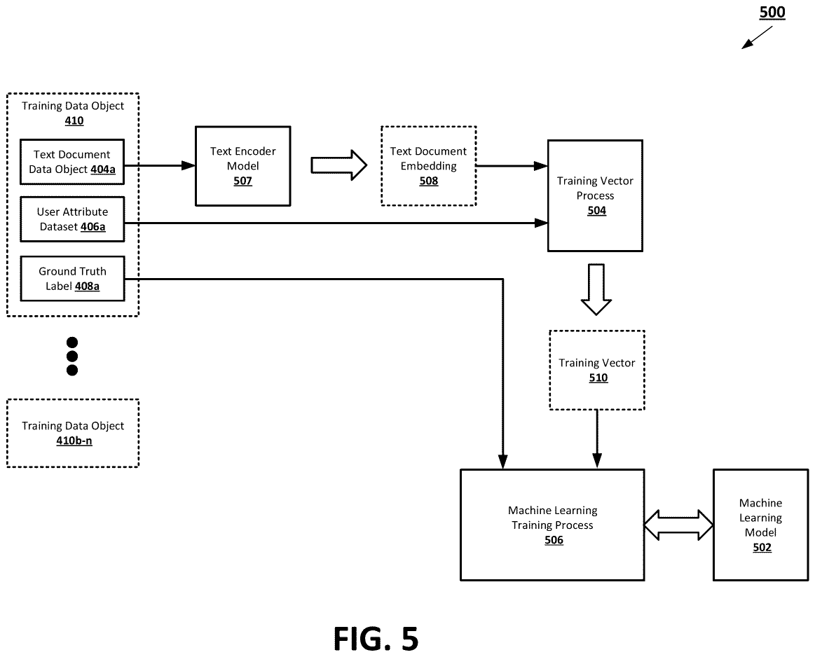

FIG. 5 is a dataflow diagram 500 showing example data structures, modules, and/or pipelines for training a machine learned model in accordance with some embodiments discussed herein. In some embodiments, the dataflow diagram 500 provides a training stage that utilizes one or more training data objects 410 to generate one or more training vectors (e.g., an optimized training dataset) for a machine learned model 502. The dataflow diagram 500 includes a training vector process 504 and a machine learning training process 506. In various embodiments, the predictive computing entity 106 may perform the training vector process 504 and/or the machine learning training process 506. The training vector process 504 may process one or more attribute datasets and one or more text document embeddings associated with one or more training data objects 410 to generate one or more training vectors for utilization during training of the machine learned model 502. In some embodiments, the training vector process 504 may process one or more portions of the training data object 410. For example, the training vector process 504 may process the user attribute dataset 406a and a text document embedding 508 associated with the training text-based prompt 404a to generate a training vector 510 for the training data object 410. In some embodiments, the training vector process 504 may utilize a text encoder model 507 to generate the text document embedding 508 by encoding the training text-based prompt 404a. In some embodiments, the training vector process 504 may generate the training vector 510 by mapping the text document embedding 508 that corresponds to the training text-based prompt 404a (e.g., the training text-based prompt 404a of the training data object 410) to the user attribute dataset 406a of the training data object 410.

More particularly, in some embodiments, a text document embedding 508 is generated by encoding the training text-based prompt 404a of the training data object 410. For example, the text document embedding 508 may be generated using a text encoder model 507. In some embodiments, the text document embedding 508 may be a data entity that describes a vector representation of textual information associated with a text document. In some examples, a text document embedding may be a fixed-length vector that represents words and/or sentences within a text document. By way of example, the text document embedding 508 may include a vectorized representation of a text-based prompt. The text document embedding 508 may include a vectorized representation of one or more text segments and/or instructions of the script defined by a text-based prompt.

In some embodiments, the text encoder model 507 is a data entity that describes parameters, hyper-parameters, and/or defined operations of a rules-based and/or machine learned model (e.g., model including at least one of one or more rule-based layers, one or more layers that depend on trained parameters, coefficients, and/or the like). In some embodiments, a text encoder model 507 may be a machine learning embedding model. A text encoder model 507 may include one or more text encoder models configured, trained (e.g., jointly, separately, etc.), and/or the like to encode textual data into one or more text document embeddings. A text encoder model 507 may include one or more of any type of machine learned model including one or more supervised, unsupervised, semi-supervised, reinforcement learning models, and/or the like. In some examples, a text encoder model 507 may include multiple models configured to perform one or more different stages of an embedding process.

In some embodiments, a text encoder model 507 may be trained to factorize one or more inputs, such as one or more text strings, to generate a text document embedding 508. In some examples, a text encoder model 507 may be trained such that a latent space of the text encoder model 507 is representative of certain semantic domains/contexts, such as a clinical domain. For example, a text encoder model 507 may be trained to generate embeddings representative of one or more learned (and/or prescribed, etc.) relationships between one or more words, phrases, and/or sentences. By way of example, a text encoder model 507 may represent a semantic meaning of a word and/or sentence differently in relation to other words and/or sentences, and/or the like. The text encoder model 507 may include any type of embedding model finetuned on information for a particular search domain. By way of example, a text encoder model 507 may include one or more of bi-directional encoder representations from transformers (“BERT”), sentence BERT (“SBERT”), ClinicalBERT, Word2Vec, global vectors for word representation (“GloVe”), Doc2Vec, InferSent, Universal Sentence Encoder, and/or the like. In some examples, the text encoder model 507 may be finetuned on a domain-specific dataset, such as a plurality of historical text-based prompts.

In some embodiments, the text document embedding 508 is a data entity that describes a vector representation of textual information associated with a text document. In some examples, a text document embedding 508 may be a fixed-length vector that represents words and/or sentences within a text document. By way of example, the text document embedding 508 may include a vectorized representation of a text-based prompt. The text document embedding 508, for example, may include a vectorized representation of one or more text segments and/or instructions of the script defined by a text-based prompt.

In some embodiments, a training vector 510 for the training data object 410 is generated by concatenating the text document embedding 508 with the user attribute dataset 406a of the training data object 410.

In some embodiments, the training vector 510 is an input vector that is used to train a machine learned model. For example, the training vector 510 may include an input vector that is associated with a ground truth label 408a.

In some embodiments, the input vector is a vectorized input for a machine learned model 502. An input vector, for example, may include a vectorized representation of information that is engineered for a particular machine learned model. The information, for example, may include predictive features for improving the performance of the machine learned model 502. In some embodiments, the input vector may include a concatenation of one or more different vectors to form a comprehensive vector that may improve the performance of a machine learned model with respect to a particular task, such as prompt classification. For example, the input vector may include a concatenation of a text document embedding 508 of a text-based prompt, a user attribute dataset 406a and/or one or more contextual attributes such as sentiment analysis classifications, and/or the like. In this manner, the input vector may enable a machine learned model 502 to learn relationships between textual features and a user features. As described herein, this may adapt traditional machine learned models to new fields, such as the subjective analysis of an impact of a prompt on a user.

In some embodiments, to generate the training vector 510, the training vector process 504 may determine a metadata feature set associated with one or more script branch instruction sets of the training text-based prompt 404a. Additionally, the training vector process 504 may map the text document embedding 508 to the user attribute dataset 406a based on the metadata feature set. The metadata feature set may be a collection of data constructs that describes features and/or attributes associated with a text-based prompt. In some embodiments, the metadata feature set may be associated with metadata and/or other data associated with the one or more script branch instruction sets. For example, the metadata feature set may capture nuances, patterns, and/or relationships associated with the one or more script branch instruction sets.

In some embodiments, to generate the training vector 510, the training vector process 504 may determine a sentiment classification for the training text-based prompt 404a. Additionally, the training vector process 504 may map the text document embedding 508 to the user attribute dataset 406a based on the sentiment classification. The sentiment classification may be a data construct that describes one or more classifications, predictions, and/or inferences associated with sentiment for a text-based prompt. For example, the sentiment classification may classify sentiment associated with a text-based prompt. Sentiment may be related to tone, emotion, branching, and/or another type of sentiment for text associated with a text-based prompt. In some embodiments, the sentiment classification may be determined based on one or more natural language processing technique applied to a text-based prompt.

In some embodiments, the machine learned model 502 is trained, during a machine learning training process 506, based on the training vector 510 and the ground truth label 408a of the training data object 410.

In some embodiments, the machine learned model 502 to a hardware and/or software architecture having one or more parameters (e.g., coefficient(s), weight(s), biase(s), activation function(s) and/or action function type(s) in examples where the activation function and/or function type is determined as part of training, clustering centroid(s)/medoid(s), partition(s)) determined as a result of training the machine-learned model based at least in part on training hyperparameters and/or structural hyperparameters defining the model's architecture. In some examples, structural hyperparameter(s) may define component(s) of the model's architecture and/or their configuration/order, such as, for example, the configuration/order specifying which output(s) of one component are provided as input to other component(s); a number, type, and/or configuration of component(s) per layer, a number of layers of the model, a number of input nodes in an input layer of the model, a number of output nodes of an output layer of the model, component dimension (e.g., input size versus output size), temperature, and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., embedding model(s), generative pre-trained transformer(s) (GPT(s))), neural network(s), multi-layer perceptron(s), Kolmogorov-Arnold network(s), clustering algorithm(s), support vector machine(s), etc.

Additional or alternate hyperparameter(s) (i.e., training hyperparameter(s)) may be used as part of training the machine-learned model. In some examples, the training hyperparameter(s), in addition to the training data and/or input data, may affect determining the parameter(s) of the machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate optimization algorithm type (e.g., gradient descent, adaptive, stochastic) used to determine an alteration to one or more parameters of one or more components of the machine-learned model to reduce the loss determined by the loss function, and/or the like. In some examples, the structural hyperparameters and/or the training hyperparameters may be determined by a hyperparameter optimization algorithm or based on user input, such as a software component written by a user or generated by a machine-learned model. The machine learned model 502 may include any type of model configured, trained, and/or the like to generate a classification score for a model input. The machine learned model 502 may include one or more of any type of machine learned model 502 including one or more supervised, unsupervised, semi-supervised, and/or reinforcement learning models. In some embodiments, the machine learned model 502 may include a single machine-learned model or multiple machine-learned model models configured to perform one or more different stages of a prediction process.

In some embodiments, a machine learned model 502 is a supervised machine learned model that is pre-trained using one or more supervisory and/or semi-supervised training techniques, such as backpropagation of errors, and/or the like. A machine learned model 502 may be trained using the training dataset that includes a set of training data objects 410 associated with one or more training text-based prompts. In some examples, the labels may comprise partition(s), centroid(s) indicated by a user, class(es), k for use in supervised clustering algorithm training, a ground truth value, a ground truth classification, and/or the like. In an example where the machine-learned model is a semi-supervised machine-learned model, the training dataset may comprise previous input(s) to and/or previous output(s) generated by the machine-learned model or another machine-learned model. The machine learned model 502 may be trained based at least in part on providing a first training input of the set of training inputs to the machine-learned model, determining an output by the machine-learned model, determining a difference between the output and a first training output of the set of training outputs, determining a loss by a loss function based at least in part on the difference, and altering one or more parameters of the machine learned model 502 to reduce the loss (e.g., using a loss optimization algorithm, such as gradient descent). In some examples, this process may be iteratively repeated for up to all of the inputs of the set of training inputs, respectively.

In some embodiments, the machine learning training process 506 may utilize the training vector 510 and the ground truth label 408a of the training data object 410 to train the machine learned model 502. For example, the machine learning training process 506 may train the machine learned model 502 based on the training vector 510 and the ground truth label 408a to provide a trained version of the machine learned model 502. In some embodiments, the machine learned model 502 may be trained using supervised learning associated with the training vector 510 and the ground truth label 408a. The machine learning training process 506 may utilize the training vector 510 for training the machine learned model 502 to provide an improved machine learned model as compared to merely utilizing the training data object 410 for training the machine learned model 502. For example, the training vector 510 and/or the ground truth label 408a may be included in an optimized training dataset for utilization during one or more training stages for the machine learned model 502.

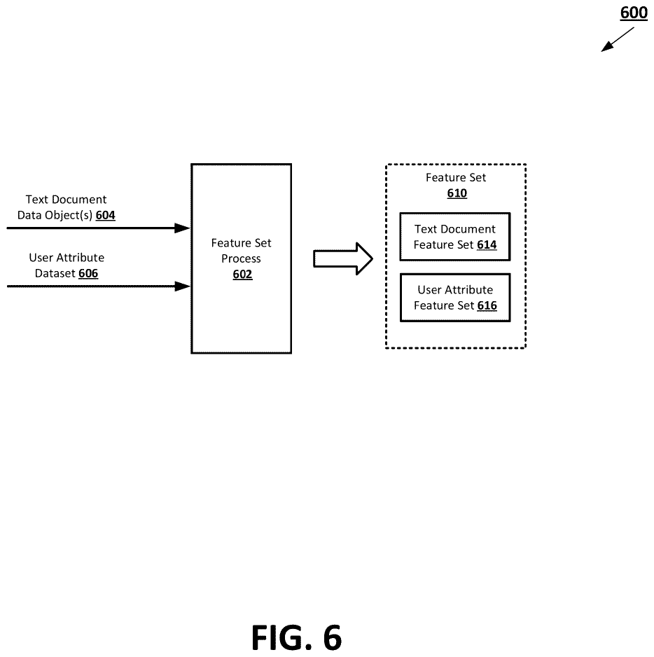

FIG. 6 is a dataflow diagram 600 showing example data structures, modules, and/or pipelines for generating a feature set in accordance with some embodiments discussed herein. In some embodiments, the dataflow diagram 600 provides an inference stage that utilizes a set of text-based prompts and an attribute set for a user identifier to generate a feature set for a trained version of the machine learned model 502. The dataflow diagram 600 includes a feature set process 602. In various embodiments, the predictive computing entity 106 may perform the feature set process 602.

The feature set process 602 may process a set of input text-based prompts 604 and a user attribute dataset 606 to generate a feature set 610. In some embodiments, the set of input text-based prompts 604 includes at least one input text-based prompt that is not included in the one or more training text-based prompts 404 utilized during training of the machine learned model 502. For example, the training text-based prompt may include a first branching script that is generated before the machine learned model 502 is trained and the input text-based prompt may include a second branching script that is generated after the machine learned model 502 is trained.

In other embodiments, the set of input text-based prompts 604 corresponds to the one or more training text-based prompts 404 utilized during training of the machine learned model 502. In some embodiments, the user attribute dataset 606 is distinct from the one or more user attribute datasets 406 utilized for training the machine learned model 502. For example, the user attribute dataset 606 may be associated with a user identifier that is distinct from any user identifier associated with the one or more user attribute datasets 406 utilized for training the machine learned model 502. In some embodiments, the feature set process 602 may generate the feature set 610 for utilization via one or more other inference stages associated with the machine learned model 502.

In some embodiments, the feature set process 602 may receive the set of input text-based prompts 604 and/or the user attribute dataset 606 from one or more data sources. In some embodiments, the set of input text-based prompts 604 and/or the user attribute dataset 606 may be received from one or more third-party data sources. In some embodiments, the one or more third-party data sources may be one or more electronic health record data source. The one or more third-party data sources may store a plurality of data elements. In some embodiments, a data element of the plurality of input data elements may correspond to text and/or one or more images. In some embodiments, a data element of the plurality of input data elements may be configured in a particular data format such as, for example, PDF, JSON, XML, FHIR, JPEG, DICOM, PNG, TIFF, BMP, and/or another type of data format. In some embodiments, a data element of the plurality of input data elements may correspond to at least a portion of a lab report, a clinical note, a medical form, or another type of electronic health record.

In some embodiments, the set of input text-based prompts 604 may respectively include a textual description that describes a respective script. For example, the set of input text-based prompts 604 may respectively include text that describes one or more script branch instruction sets associated with one or more prompts, cues, voice tones, and/or other descriptive information for performing a script. In some embodiments, the set of input text-based prompts 604 may respectively include one or more attributes corresponding to particular user identifier. In some embodiments, the user attribute dataset 606 may include one or more attributes associated with a user profile, census data, demographics data, clinical data, and/or other data associated with a user identifier.

In some embodiments, the feature set process 602 may aggregate, combine, format, and/or transform one or more portions of the set of input text-based prompts 604 and/or the user attribute dataset 606 to generate the feature set 610. For example, the feature set 610 may include a text document feature set 614 associated with the set of input text-based prompts 604 and/or a user attribute feature set 616 associated with the user attribute dataset 606a.

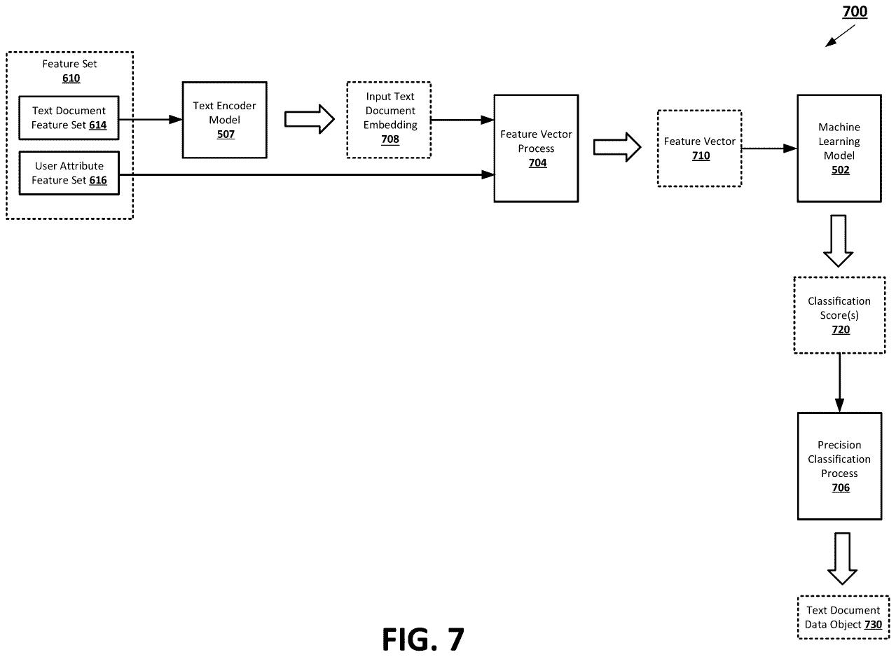

FIG. 7 is a dataflow diagram 700 showing example data structures, modules, and/or pipelines for deploying a machine learned model in accordance with some embodiments discussed herein. In some embodiments, the dataflow diagram 700 provides an inference stage that utilizes a feature set to generate a feature vector for a trained version of the machine learned model 502. The dataflow diagram 700 includes a feature vector process 704 and a precision classification process 706. In various embodiments, the predictive computing entity 106 may perform the feature vector process 704 and/or the precision classification process 706.

The feature vector process 704 may process one or more portions of the feature set 610 to generate an input vector 710 for utilization via deployment of the machine learned model 502. In some embodiments, the feature vector process 704 may process the user attribute feature set 616 and an input text document embedding 708 associated with the text document feature set 614 to generate the input vector 710 for the feature set 610. In some embodiments, the feature vector process 704 may utilize the text encoder model 507 to generate the input text document embedding 708 by encoding the text document feature set 614. In some embodiments, the feature vector process 704 may generate the input vector 710 by mapping one or more portions of the input text document embedding 708 to the user attribute feature set 616.

In some embodiments, the input text document embedding 708 and an input user attribute dataset (e.g., user attribute feature set 616) associated with an input user-text pair is received. In some examples, the input text document embedding 708 is generated by encoding the input text-based prompt of the input user-text pair. The input vector 710 may be generated by concatenating the input user attribute dataset with the input text document embedding 708.

In some embodiments, the machine learned model 502 may utilize the input vector 710 to generate one or more classification scores 720. For example, the classification score 720 may be generated for the input text-document pair using the machine learned model 502 and based on the input text document embedding 708. For example, the input vector 710 may be provided as input to the machine learned model 502. Additionally, performance of the machine learned model 502 may be initiated based on the input vector 710 to generate the one or more classification scores 720. In some embodiments, the one or more classification scores 720 may be associated with the user attribute dataset 606. For example, the one or more classification scores 720 may respectively correspond to a likelihood that a user identifier associated with the user attribute dataset 606 will interact with a particular text-based prompt of the set of input text-based prompts 604. In some embodiments, an interaction with particular text-based prompt of the set of input text-based prompts 604 may be via a user interface and/or a user device associated with the user identifier.

A user interface may be an electronic interface that provides a display and/or a visualization to a user via a user computing device. In some embodiments, a user interface provides a GUI and/or associated GUI wizard (e.g., executable code configured to control a functionality of GUI) that provides one or more interactive interface screens, representations, and/or widgets for interacting with a user. A user interface, for example, may be configured to provide, for display to a user, a visualization associated with a text-based prompt. In some embodiments, a user interface may be configured to provide a visual data for a script associated with a text-based prompt. In some embodiments, a visualization associated with a script may be arranged relative to interactive widgets to enable user input with respect to the script. The interactive widgets, for example, may enable a real-time workflow associated with a script. In this manner, a user interface may provide an interface between a user and a platform that enables a user to selectively a contribute to the real-time workflow associated with a script.

A user interface may be specially configured to reduce the time, burden, and processing resources traditionally expended to ingest data from a text-based prompt. To do so, a user interface may arrange an interactive representation relative to a plurality of prepopulated target data type representations and corresponding interactive widgets. The interactive representation and/or the interactive widgets may be arranged to accommodate small screen sizes, such as mobile devices, laptops, etc., without reducing the efficacy of a reviewing process. This, in turn, allows the performance of traditionally complex data matching operations from a client device with small form factors.

In some embodiments, a classification score of the one or more classification scores 720 is a data entity that describes a binary and/or probabilistic measure of a likelihood that a user identifier will interact with a particular text-based prompt. For example, a classification score of the one or more classification scores 720 may be a probability that a user identifier will interact with a particular text-based prompt. A classification score, for example, may include a real number, percentage, ratio, and/or any other likelihood representation. In some embodiments, a classification score may be determined and/or weighted based on a manner of communication via a user device associated with a user identifier.

The precision classification process 706 may determine a text-based prompt 730 based on the one or more classification scores 720. For example, a plurality of classification scores that respectively correspond to a plurality of input text documents may be generated using the machine learned model 502 and based on a plurality of input text document embeddings. A particular input text document for a user from the plurality of input text documents may be identify based on the plurality of classification scores.

In some examples, the precision classification process 706 may select the text-based prompt 730 from the set of input text-based prompts 604 based on the one or more classification scores 720. For example, the precision classification process 706 may determine a maximum classification score from the one or more classification scores 720. Additionally, the precision classification process 706 may select the text-based prompt 730 from the set of input text-based prompts 604 based on a determination that the text-based prompt 730 is associated with the maximum classification score. In some embodiments, a rendering of a visualization associated with the text-based prompt 730 may be initiated via a user interface of a user computing device.

In some embodiments, an updated training data set for the machine learned model 502 may be generated by updating the training data set that includes the training data object 410 and/or the one or more training data objects 410b-n. For example, the updated training data set for the machine learned model 502 may be generated by updating the training data set based on the user attribute feature set 616 and/or the text-based prompt 730. In some embodiments, the trained version of the machine learned model 502 may be retrained based on the updated training data set and/or the classification score associated with the text-based prompt 730 (e.g., the classification score associated with the user attribute feature set 616).

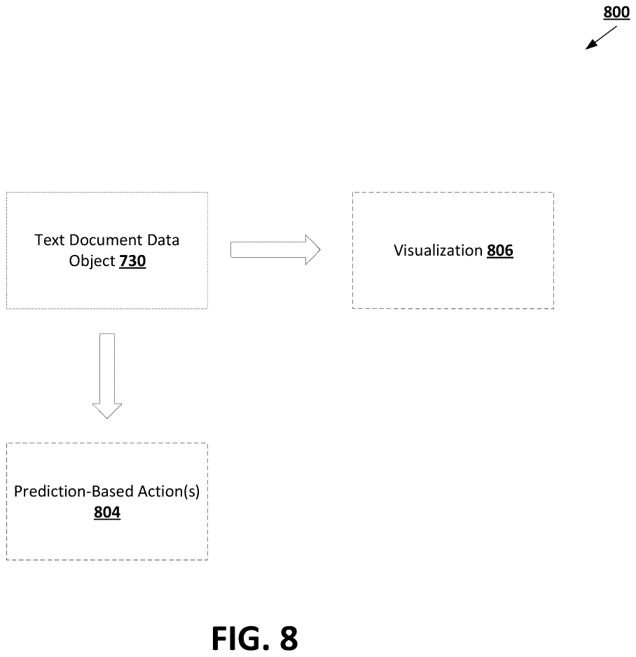

FIG. 8 illustrates an example system 800 for providing prediction-based actions and/or visualizations, in accordance with one or more embodiments of the present disclosure. The system 800 includes the text-based prompt 730 provided by the machine learned model 502 and/or the precision classification process 706. In one or more embodiments, one or more prediction-based actions 804 are performed based on the text-based prompt 730. For example, the performance of the one or more prediction-based actions 804 may be initiated based on the text-based prompt 730. In some embodiments, the performance of the one or more prediction-based actions 804 may be initiated via a machine learned model such as the machine learned model 502 or another machine learned model communicatively coupled to the machine learned model 502. For example, in some embodiments, the performance of the one or more prediction-based actions 804 may be initiated via a predictive machine learned model that is trained for a different predictive task than the machine learned model 502. In some embodiments, data associated with the text-based prompt 730 may be stored in a storage system, such as the volatile memory 215, the non-volatile memory 210, the volatile memory 322, or the non-volatile memory 324. The data stored in the storage system may be employed for providing user interface renderings, graphical visualizations, machine learning, recommendations, reporting, decision-making purposes, operations management, healthcare management, and/or other purposes. In certain embodiments, the data stored in the storage system may be employed to provide one or more insights to assist with healthcare decision making processes, such as, medical decisions for a patient. Additionally or alternatively, one or more machine learned models (e.g., the machine learned model 502) may be retrained based on one or more features associated with the text-based prompt 730. For example, one or more relationships between features mapped in the machine learned model 502 may be adjusted (e.g., refitted, tuned, etc.) based on data associated with the text-based prompt 730. In another example, cross-validation, hyperparameter optimization, and/or regularization associated with the machine learned model 502 may be adjusted based on one or more features associated with the text-based prompt 730. Additionally or alternatively, a visualization 806 may be generated based on the text-based prompt 730. The visualization 806 may include, for example, one or more interactive graphical elements for a user interface (e.g., an electronic interface of a user device) based on the text-based prompt 730.

A predictive machine learned model may be a data entity that describes parameters, hyper-parameters, and/or defined operations of a rules-based and/or machine learned model (e.g., model including at least one of one or more rule-based layers, one or more layers that depend on trained parameters, coefficients, and/or the like). A predictive machine learned model may include any type of model configured, trained, and/or the like to determine a likelihood of a match between two data types, as described herein. A predictive machine learned model may include one or more of any type of machine learned model including one or more supervised, unsupervised, semi-supervised, and/or reinforcement learning models. In some embodiments, a predictive machine learned model may include multiple models configured to perform one or more different stages of a data matching process.

In some embodiments, a predictive machine learned model includes a neural network architecture that is trained using one or more supervised and/or reinforcement learning techniques. By way of example, a predictive machine learned model may be initially trained using one or more supervisory training techniques (e.g., back propagation of errors, gradient descent optimization, etc.) and a labelled training dataset. In some examples, the predictive machine learned model may be continuously finetuned (e.g., retrained, etc.) using one or more reinforcement training techniques (e.g., back propagation of errors, agent-led learning, etc.) and historical data representative, such as historical mapped format data objects. By way of example, a predictive machine learned model may include pretrained machine learning service that is trained to identify proposed type matches between two data types. The type matches, for example, may be derived from domain logic and/or a plurality of predictive features that identify relevant element clusters. The predictive features may be partially predefined (e.g., during an initial training stage) and partially learned (e.g., during a reinforcement training stage) to adapt the predictive machine learned model over time.

In some examples, a predictive machine learned model may be used to identify one or more target data types for an input data type. For example, a predictive machine learned model may be trained for a target data format using a labelled training set with a plurality of training entries, each including a training data element of a training data type and a corresponding ground truth target data type. The predictive machine learned model may be continuously refined based on user input by providing an explainable artificial intelligence-based mapping confirmation loop. The confirmation loop, for example, may provide a user with an opportunity to review and providing user input for a type match (and/or match score thereof) output by the a predictive machine learned model. The user input provided by the user may be used as a ground truth for finetuning the predictive machine learned model.

By way of example, before applying a predictive machine learned model, a labelled training dataset may be pre-processed to identify a plurality of predefined features for each of a plurality of target data types. The plurality of predefined features, for example, may be identified from a plurality training entries associated with each of the plurality of target data types. The predictive machine learned model may be tuned with custom hyper parameters to increase model performance (e.g., an F1 score 94%, etc.) within increasing model size (e.g., 0.6 MB, etc.). Reinforcement learning may be continuously applied to continuously adapt the predictive machine learned model to data elements as they change over time.

In some embodiments, the one or more prediction-based actions 804 may include automated user interface actions, automated alerts, automated instructions to user devices, and/or automated adjustments to allocations of computing resources. Further, the one or more prediction-based actions 804 may include automated physician notification actions, automated patient notification actions, automated appointment scheduling actions, automated prescription recommendation actions, automated record updating actions, automated datastore updating actions, automated workforce management operational management actions, automated server load balancing actions, automated resource allocation actions, automated pricing actions, automated plan update actions, automated alert generation actions, generating one or more electronic communications, and/or the like. The one or more prediction-based actions 804 may further include displaying visual renderings of the aforementioned examples of prediction-based actions in addition to values, charts, and representations associated with the one or more policy scores and the prediction output using a prediction output user interface such as, for example, the visualization 806.

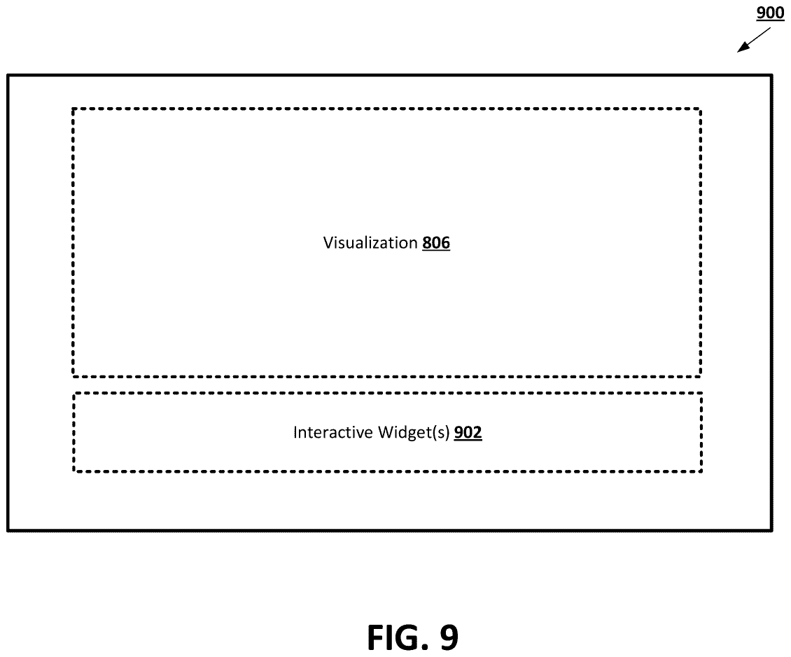

FIG. 9 illustrates an example user interface 900, in accordance with one or more embodiments of the present disclosure. In one or more embodiments, the user interface 900 is, for example, an electronic interface (e.g., a graphical user interface) of the client computing entity 102. In various embodiments, the user interface 900 may be provided via the output device 316 of the client computing entity 102. The user interface 900 may be configured to render an interactive visualization associated with the text-based prompt 730. For example, the user interface 900 may be configured to render the visualization 806. Additionally or alternatively, the user interface 900 may be configured to render one or more interactive widgets 902. In various embodiments, the visualization 806 may provide an interactive visualization associated with the text-based prompt 730 to initiate a rendering of a script and/or execution of one or more script branch instruction sets of the text-based prompt 730. In some embodiments, the one or more interactive widgets 902 may be configured to receive user input associated with the rendering of the script and/or execution of the one or more script branch instruction sets of the text-based prompt 730. In various embodiments, the user interface 900 may be configured as a web portal interface (e.g., a medical provider portal, etc.) for managing the machine learned model 502 and/or text-based prompts. In some embodiments, a user interaction with a particular widget of the one or more interactive widgets 902 may result in rendering of a new interactive widget and/or a new user interface.

In some embodiments, the visualization 806 rendered via the user interface 900 may provide a rendering of a visualization associated with a text-based prompt provided by the machine learned model 502 during training of the machine learned model 502. Additionally, a ground truth label associated with the text-based prompt may be generated based on a user interaction with respect to the visualization 806 and/or the one or more interactive widgets 902 associated with the text-based prompt.

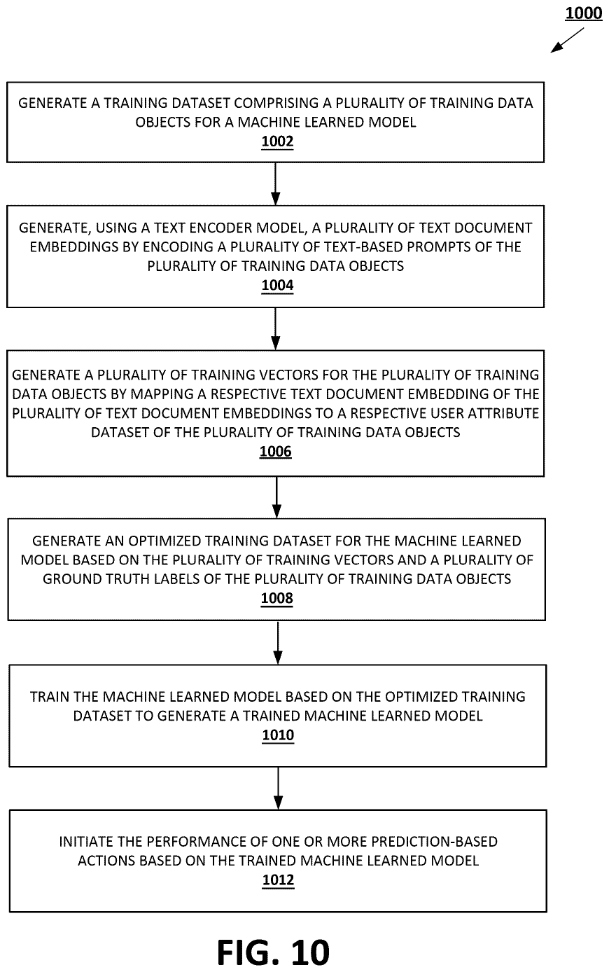

FIG. 10 is a flowchart diagram of an example process 1000 for training and/or deploying a machine learned model based on a training vector associated with a text document embedding and an attribute set in accordance with some embodiments discussed herein. The process 1000 may be implemented by one or more computing devices, entities, and/or systems (e.g., the computing system 101 and/or the predictive computing entity 106) described herein. For example, via the various steps/operations of the process 1000, the computing system 101 may leverage improved data processing and/or machine learning techniques to optimize a training dataset for a machine learned model. By doing so, the process 1000 enables improved prediction-based action related to a defined domain task, while ensuring data quality and/or optimized computing resources in view of various data processing and/or machine learning rules.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 includes, at step/operation 1002, generating a training dataset comprising a plurality of training data objects for a machine learned model. For example, the computing system 101 may receive (i) a plurality of text-based prompts, (ii) a plurality of user attribute datasets that respectively corresponds to a plurality of user identifiers, and/or (iii) a ground truth label set comprising a plurality of ground truth labels that respectively corresponds to a plurality of user-text pairs. Additionally, the computing system 101 may generate a training data object that includes (i) a ground truth label of the plurality of ground truth labels that corresponds to a user-text pair of the plurality of user-text pairs, (ii) a user attribute dataset of the plurality of user attribute datasets that corresponds to a user identifier of the user-text pair, and/or (iii) a text-based prompt of the plurality of text-based prompts that corresponds to the user-text pair. In some embodiments, the computing system 101 may initiate, via a user interface of a user computing device, a rendering of a visualization associated with the text-based prompt. Additionally, in some embodiments, the computing system 101 may generate the ground truth label based on a user interaction with respect to the visualization associated with the text-based prompt. In some embodiments, the machine learned model is trained using back propagation of errors.

In some embodiments, the process 1000 includes, at step/operation 1004, generating, using a text encoder model, a plurality of text document embeddings by encoding a plurality of text-based prompts of the plurality of training data objects. For example, the computing system 101 may generate, using a text encoder model, a plurality of text document embeddings by encoding the plurality of text-based prompts.

In some embodiments, the process 1000 includes, at step/operation 1006, generating a plurality of training vectors for the plurality of training data objects by mapping a respective text document embedding of the plurality of text document embeddings to a respective user attribute dataset of the plurality of training data objects. For example, the computing system 101 may generate a training vector for the training data object by mapping a text document embedding of the plurality of text document embeddings that corresponds to the training data object to the user attribute dataset of the training data object. In some embodiments, the computing system 101 may determine a metadata feature set associated with one or more script branch instruction sets of the text-based prompt. Additionally, in some embodiments, the computing system 101 may map the text document embedding to the user attribute dataset based on the metadata feature set. In some embodiments, the computing system 101 may determine a sentiment classification for the text-based prompt. Additionally, in some embodiments, the computing system 101 may additionally or alternatively map the text document embedding to the user attribute dataset based on the sentiment classification.

In some embodiments, the process 1000 includes, at step/operation 1008, generating an optimized training dataset for the machine learned model based on the plurality of training vectors and a plurality of ground truth labels of the plurality of training data objects.

In some embodiments, the process 1000 includes, at step/operation 1010, training the machine learned model based on the optimized training dataset to generate a trained machine learned model. For example, the computing system 101 may train the machine learned model based on the training vector and the ground truth label of the training data object. In some embodiments, the computing system 101 may train the machine learned model using supervised learning associated with the training vector and the ground truth label set,

In some embodiments, the process 1000 includes, at step/operation 1012, initiating the performance of one or more prediction-based actions based on the trained machine learned model.

In some embodiments, the plurality of text-based prompts is a first plurality of text-based prompts and the plurality of text document embeddings is a first plurality of text document embeddings. Additionally, in some embodiments, the computing system 101 may receive (i) a second plurality of text-based prompts and (ii) a user attribute dataset that is distinct from the plurality of user attribute datasets. In some embodiments, the computing system 101 may generate a second plurality of text document embeddings by encoding the second plurality of text-based prompts. In some embodiments, the computing system 101 may generate a feature set based on the second plurality of text document embeddings and the user attribute dataset. In some embodiments, the computing system 101 may initiate the performance of the trained machine learned model based on the feature set to generate a classification score associated with the user attribute dataset. In some embodiments, the second plurality of text-based prompts includes at least one text-based prompt that is not included in the first plurality of text-based prompts.

In some embodiments, the computing system 101 may generate respective classification scores for respective text-based prompts of the second plurality of text-based prompts. In some embodiments, the computing system 101 may select a particular text-based prompt from the second plurality of text-based prompts based on the respective classification scores.

In some embodiments, the computing system 101 may determine a maximum classification score from the respective classification scores. In some embodiments, the computing system 101 may select the particular text-based prompt from the second plurality of text document data based on a determination that the particular text-based prompt is associated with the maximum classification score.

In some embodiments, the computing system 101 may initiate a rendering of a visualization associated with the particular text-based prompt via a user interface of a user computing device.

In some embodiments, the computing system 101 may generate an updated training data set by updating the training data set based on the second plurality of user attribute datasets and the particular text-based prompt. In some embodiments, the computing system 101 may retrain the trained machine learned model based on the updated training data set and the classification score associated with the second plurality of user attribute datasets.

In some embodiments, the computing system 101 may receive an input text document embedding and an input user attribute dataset associated with an input user-text pair. In some embodiments, the computing system 101 may generate an input vector by concatenating the input user attribute dataset with the input text document embedding. In some embodiments, the computing system 101 may generate, using the machine learned model and based on the input text document embedding, a classification score for the input text document embedding. In some embodiments, the computing system 101 may generate, using the text encoder model, the input text document embedding by encoding an input text-based prompt of the input user-text pair. In some embodiments, the training text-based prompt comprises a first branching script that is generated before the machine learned model is trained and the input text-based prompt comprises a second branching script that is generated after the machine learned model is trained. In some embodiments, the computing system 101 may generate, using the machine learned model and based on a plurality of input text document embeddings, a plurality of classification scores that respectively correspond to a plurality of input text documents. In some embodiments, the computing system 101 may identify, based on the plurality of classification scores, a particular input text document for a user from the plurality of input text documents. In some embodiments, the computing system 101 may initiate a rendering of a visualization associated with the particular input text document via a user interface of a user computing device. In some embodiments, the computing system 101 may receive user input identifying a user interaction with the visualization. In some embodiments, the computing system 101 may retrain the trained machine learned model based on the input text document embedding and the user interaction.

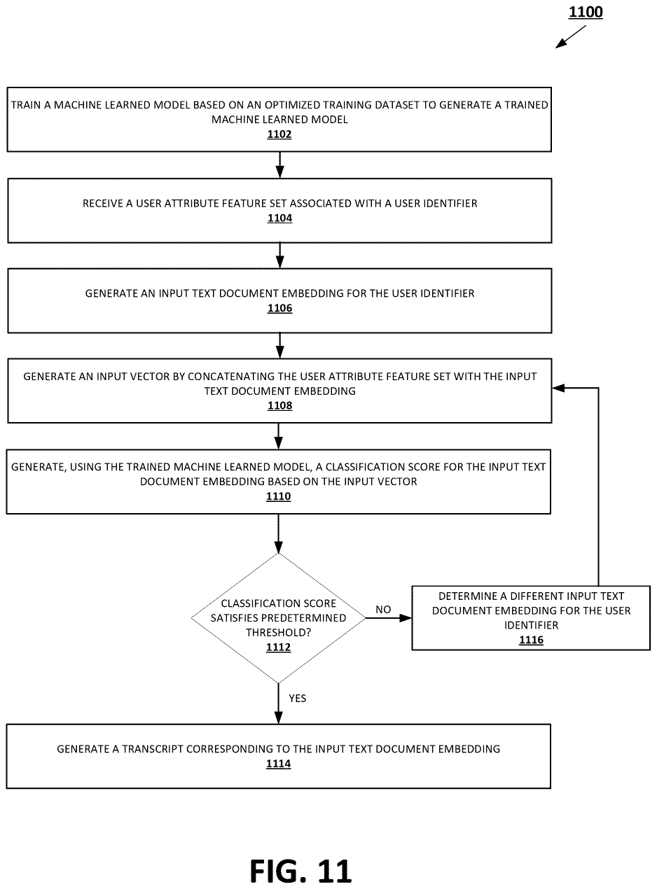

FIG. 11 is a flowchart diagram of an example process 1000 for training and/or deploying a machine learned model in accordance with some embodiments discussed herein. The process 1100 may be implemented by one or more computing devices, entities, and/or systems (e.g., the computing system 101 and/or the predictive computing entity 106) described herein. For example, via the various steps/operations of the process 1100, the computing system 101 may leverage improved data processing and/or machine learning techniques to optimize a training dataset for a machine learned model. By doing so, the process 1100 enables improved prediction-based action related to a defined domain task, while ensuring data quality and/or optimized computing resources in view of various data processing and/or machine learning rules.

FIG. 11 illustrates an example process 1100 for explanatory purposes. Although the example process 1100 depicts a particular sequence of steps/operations, the sequence may be altered without departing from the scope of the present disclosure. For example, some of the steps/operations depicted may be performed in parallel or in a different sequence that does not materially impact the function of the process 1100. In other examples, different components of an example device or system that implements the process 1100 may perform functions at substantially the same time or in a specific sequence.

In some embodiments, the process 1100 includes, at step/operation 1102, training a machine learned model based on an optimized training dataset to generate a trained machine learned model.

In some embodiments, the process 1100 includes, at step/operation 1104, receiving a user attribute feature set associated with a user identifier.

In some embodiments, the process 1100 includes, at step/operation 1106, generating an input text document embedding for the user identifier.

In some embodiments, the process 1100 includes, at step/operation 1108, generating an input vector by concatenating the user attribute feature set with the input text document embedding.

In some embodiments, the process 1100 includes, at step/operation 1110, generating, using the trained machine learned model, a classification score for the input text document embedding based on the input vector.

In some embodiments, the process 1100 includes, at step/operation 1112, a determination as to whether the classification score satisfies a predetermined threshold. If yes, the process 1100 proceed to step/operation 1114. If no, the process 1100 proceed to step/operation 1116.

In some embodiments, the process 1100 includes, at step/operation 1114 and upon determining that the classification score satisfies the predetermined threshold, generating a transcript corresponding to the input text document embedding. In some embodiments, the transcript is a script associated with one or more script branch instruction sets.

In some embodiments, the process 1100 includes, at step/operation 1116 and upon determining that the classification score does not satisfy the predetermined threshold, determining a different input text document embedding for the user identifier. In some embodiments, the process 1100 may return to step/operation 1108 after step/operation 1116 to enable generation of a different classification score associated with the different input text document embedding.

In some embodiments, the computing system 101 may generating a training data object based on a user-text pair, wherein the training data object comprises (i) the ground truth label, (ii) a user attribute dataset that corresponds to the user identifier, and (iii) a training text-based prompt that corresponds to the user-text pair. In some embodiments, the computing system 101 may generate, using the text encoder model, the text document embedding by encoding the training text-based prompt of the training data object. In some embodiments, the computing system 101 may generate the training vector for the training data object by concatenating the text document embedding with the user attribute dataset of the training data object. In some embodiments, the computing system 101 may train the machine learned model based on the training vector and the ground truth label of the training data object.

In some embodiments, the computing system 101 may initiate, via a user interface of a user computing device, a rendering of a visualization associated with the training text-based prompt. In some embodiments, the computing system 101 may generate the ground truth label based on a user interaction with respect to the visualization associated with the training text-based prompt.

In some embodiments, the computing system 101 may determine a metadata feature set associated with one or more script branch instruction sets of the training text-based prompt. In some embodiments, the computing system 101 may map the text document embedding to the user attribute dataset based on the metadata feature set.

In some embodiments, the computing system 101 may determine a sentiment classification for the training text-based prompt. In some embodiments, the computing system 101 may map the text document embedding to the user attribute dataset based on the sentiment classification.

In some embodiments, the computing system 101 may generate, using the text encoder model, the input text document embedding by encoding an input text-based prompt of the input user-text pair.

In some embodiments, the training text-based prompt comprises a first branching script that is generated before the machine learned model is trained and the input text-based prompt comprises a second branching script that is generated after the machine learned model is trained.

In some embodiments, the computing system 101 may generate, using the machine learned model and based on a plurality of input text document embeddings, a plurality of classification scores that respectively correspond to a plurality of input text documents. In some embodiments, the computing system 101 may identify, based on the plurality of classification scores, a particular input text document from the plurality of input text documents. In some embodiments, the computing system 101 may initiate a rendering of a visualization associated with the particular input text document via a user interface of a user computing device. In some embodiments, the computing system 101 may receive user input identifying a user interaction with the visualization. In some embodiments, the computing system 101 may retrain the machine learned model based on the input text document embedding and the user interaction. In some embodiments, the machine learned model is trained or retrained using back propagation of errors.

Some techniques of the present disclosure enable the generation of action outputs that may be performed to initiate one or more real world actions to achieve real-world effects. The data processing and machine learning techniques of the present disclosure may be used, applied, and/or otherwise leveraged to generate reliable data objects, which may help in the creation and provisioning of messages across computing entities, as well as other downstream tasks such as rendering of a visualization via a user interface. For instance, generative output, using some of the techniques of the present disclosure, may trigger the performance of actions at a client device, such as the display, transmission, and/or the like of data reflective of a visualization. In some embodiments, the visualization may trigger an alert via a user interface.

In some examples, the computing tasks may include actions that may be based on a defined domain task. A defined domain task may include any environment in which computing systems may be applied to generate a visualization and initiate the performance of computing tasks responsive to a visualization. These actions may cause real-world changes, for example, by controlling a hardware component of a user device or a server device, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: receiving, by one or more processors, a user attribute feature set associated with a user identifier for a user-text pair; generating, by the one or more processors, an input text document embedding for the user identifier; generating, by the one or more processors, an input vector by concatenating the user attribute feature set with the input text document embedding; generating, by the one or more processors and using a machine learned model that is trained based on a ground truth label and a training vector associated with a text document embedding generated by a text encoder model, a classification score for the input text document embedding based on the input vector; and upon determining that the classification score satisfies a predetermined threshold, generating, by the one or more processors, a transcript corresponding to the input text document embedding.

Example 2. The computer-implemented method of example 1, further comprising: generating a training data object based on a user-text pair, wherein the training data object comprises (i) the ground truth label, (ii) a user attribute dataset that corresponds to the user identifier, and (iii) a training text-based prompt that corresponds to the user-text pair; generating, using the text encoder model, the text document embedding by encoding the training text-based prompt of the training data object; generating the training vector for the training data object by concatenating the text document embedding with the user attribute dataset of the training data object; and training the machine learned model based on the training vector and the ground truth label of the training data object.

Example 3. The computer-implemented method of any of the above examples, further comprising: initiating, via a user interface of a user computing device, a rendering of a visualization associated with the training text-based prompt; and generating the ground truth label based on a user interaction with respect to the visualization associated with the training text-based prompt.

Example 4. The computer-implemented method of any of the above examples, wherein generating the training vector comprises: determining a metadata feature set associated with one or more script branch instruction sets of the training text-based prompt; and mapping the text document embedding to the user attribute dataset based on the metadata feature set.

Example 5. The computer-implemented method of any of the above examples, wherein generating the training vector comprises: determining a sentiment classification for the training text-based prompt; and mapping the text document embedding to the user attribute dataset based on the sentiment classification.

Example 6. The computer-implemented method of any of the above examples, wherein the machine learned model is trained using back propagation of errors.

Example 7. The computer-implemented method of any of the above examples, further comprising: generating, using the text encoder model, the input text document embedding by encoding an input text-based prompt of the input user-text pair.

Example 8. The computer-implemented method of any of the above examples, wherein the training text-based prompt comprises a first branching script that is generated before the machine learned model is trained and the input text-based prompt comprises a second branching script that is generated after the machine learned model is trained.

Example 9. The computer-implemented method of any of the above examples, further comprising: generating, using the machine learned model and based on a plurality of input text document embeddings, a plurality of classification scores that respectively correspond to a plurality of input text documents; and identifying, based on the plurality of classification scores, a particular input text document from the plurality of input text documents.

Example 10. The computer-implemented method of any of the above examples, further comprising: initiating a rendering of a visualization associated with the particular input text document via a user interface of a user computing device.

Example 11. The computer-implemented method of any of the above examples, further comprising: receiving user input identifying a user interaction with the visualization; and retraining the machine learned model based on the input text document embedding and the user interaction.

Example 12. A system comprising: one or more processors; and one or more memories storing processor-executable instructions that, when executed by the one or more processors, cause the one or more processors to perform operations comprising: receiving a user attribute feature set associated with a user identifier for a user-text pair; generating an input text document embedding for the user identifier; generating an input vector by concatenating the user attribute feature set with the input text document embedding; generating, using a machine learned model that is trained based on a ground truth label and a training vector associated with a text document embedding generated by a text encoder model, a classification score for the input text document embedding based on the input vector; and upon determining that the classification score satisfies a predetermined threshold, generating a transcript corresponding to the input text document embedding.

Example 13. The system of example 12, wherein the one or more processors further perform operations comprising: generating a training data object based on a user-text pair, wherein the training data object comprises (i) the ground truth label, (ii) a user attribute dataset that corresponds to the user identifier, and (iii) a training text-based prompt that corresponds to the user-text pair; generating, using the text encoder model, the text document embedding by encoding the training text-based prompt of the training data object; generating the training vector for the training data object by concatenating the text document embedding with the user attribute dataset of the training data object; and training the machine learned model based on the training vector and the ground truth label of the training data object.

Example 14. The system of any of the above examples, wherein the one or more processors further perform operations comprising: initiating, via a user interface of a user computing device, a rendering of a visualization associated with the training text-based prompt; and generating the ground truth label based on a user interaction with respect to the visualization associated with the training text-based prompt.

Example 15. The system of any of the above examples, wherein generating the training vector comprises: determining a metadata feature set associated with one or more script branch instruction sets of the training text-based prompt; and mapping the text document embedding to the user attribute dataset based on the metadata feature set.

Example 16. The system of any of the above examples, wherein generating the training vector comprises: determining a sentiment classification for the training text-based prompt; and mapping the text document embedding to the user attribute dataset based on the sentiment classification.

Example 17. The system of any of the above examples, wherein the machine learned model is trained using back propagation of errors.

Example 18. The system of any of the above examples, wherein the one or more processors further perform operations comprising: generating, using the text encoder model, the input text document embedding by encoding an input text-based prompt of the input user-text pair.

Example 19. The system of any of the above examples, wherein the training text-based prompt comprises a first branching script that is generated before the machine learned model is trained and the input text-based prompt comprises a second branching script that is generated after the machine learned model is trained.

Example 20. One or more non-transitory computer-readable media storing processor-executable instructions that, when executed by one or more processors, cause the one or more processors to perform operations comprising: receiving a user attribute feature set associated with a user identifier for a user-text pair; generating an input text document embedding for the user identifier; generating an input vector by concatenating the user attribute feature set with the input text document embedding; generating, using a machine learned model that is trained based on a ground truth label and a training vector associated with a text document embedding generated by a text encoder model, a classification score for the input text document embedding based on the input vector; and upon determining that the classification score satisfies a predetermined threshold, generating a transcript corresponding to the input text document embedding.

Example 21. The computer-implemented method of example 1, wherein the computer-implemented method further comprises training the machine learned model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 12, wherein the one or more processors are further configured to train the machine learned model.

Example 25. The computing system of example 24, wherein the one or more processors are comprised in a first computing entity; and the machine learned model is trained by one or more other processors comprised in a second computing entity.

Example 26. The one or more non-transitory computer-readable storage media of example 20, wherein the instructions further cause the one or more processors to train the machine learned model.

Example 27. The one or more non-transitory computer-readable storage media of example 26, wherein the one or more processors are comprised in a first computing entity; and the machine learned model is trained by one or more other processors comprised in a second computing entity.

1. A computer-implemented method comprising:
receiving, by one or more processors, a user attribute feature set associated with a user identifier for a user-text pair;
generating, by the one or more processors, an input text document embedding for the user identifier;
generating, by the one or more processors, an input vector by concatenating the user attribute feature set with the input text document embedding;
generating, by the one or more processors and using a machine learned model that is trained based on a ground truth label and a training vector associated with a text document embedding generated by a text encoder model, a classification score for the input text document embedding based on the input vector; and
upon determining that the classification score satisfies a predetermined threshold, generating, by the one or more processors, a transcript corresponding to the input text document embedding.

2. The computer-implemented method of claim 1, further comprising:
generating a training data object based on a user-text pair, wherein the training data object comprises (i) the ground truth label, (ii) a user attribute dataset that corresponds to the user identifier, and (iii) a training text-based prompt that corresponds to the user-text pair;
generating, using the text encoder model, the text document embedding by encoding the training text-based prompt of the training data object;
generating the training vector for the training data object by concatenating the text document embedding with the user attribute dataset of the training data object; and
training the machine learned model based on the training vector and the ground truth label of the training data object.

3. The computer-implemented method of claim 2, further comprising:
initiating, via a user interface of a user computing device, a rendering of a visualization associated with the training text-based prompt; and
generating the ground truth label based on a user interaction with respect to the visualization associated with the training text-based prompt.

4. The computer-implemented method of claim 2, wherein generating the training vector comprises:
determining a metadata feature set associated with one or more script branch instruction sets of the training text-based prompt; and
mapping the text document embedding to the user attribute dataset based on the metadata feature set.

5. The computer-implemented method of claim 2, wherein generating the training vector comprises:
determining a sentiment classification for the training text-based prompt; and
mapping the text document embedding to the user attribute dataset based on the sentiment classification.

6. The computer-implemented method of claim 1, wherein the machine learned model is trained using back propagation of errors.

7. The computer-implemented method of claim 1, further comprising:
generating, using the text encoder model, the input text document embedding by encoding an input text-based prompt of the input user-text pair.

8. The computer-implemented method of claim 2, wherein the training text-based prompt comprises a first branching script that is generated before the machine learned model is trained and the input text-based prompt comprises a second branching script that is generated after the machine learned model is trained.

9. The computer-implemented method of claim 1, further comprising:
generating, using the machine learned model and based on a plurality of input text document embeddings, a plurality of classification scores that respectively correspond to a plurality of input text documents; and
identifying, based on the plurality of classification scores, a particular input text document from the plurality of input text documents.

10. The computer-implemented method of claim 9, further comprising:
initiating a rendering of a visualization associated with the particular input text document via a user interface of a user computing device.

11. The computer-implemented method of claim 10, further comprising:
receiving user input identifying a user interaction with the visualization; and
retraining the machine learned model based on the input text document embedding and the user interaction.

12. A system comprising:
one or more processors; and
one or more memories storing processor-executable instructions that, when executed by the one or more processors, cause the one or more processors to perform operations comprising:
receiving a user attribute feature set associated with a user identifier for a user-text pair;
generating an input text document embedding for the user identifier;
generating an input vector by concatenating the user attribute feature set with the input text document embedding;
generating, using a machine learned model that is trained based on a ground truth label and a training vector associated with a text document embedding generated by a text encoder model, a classification score for the input text document embedding based on the input vector; and
upon determining that the classification score satisfies a predetermined threshold, generating a transcript corresponding to the input text document embedding.

13. The system of claim 12, wherein the one or more processors further perform operations comprising:
generating a training data object based on a user-text pair, wherein the training data object comprises (i) the ground truth label, (ii) a user attribute dataset that corresponds to the user identifier, and (iii) a training text-based prompt that corresponds to the user-text pair;
generating, using the text encoder model, the text document embedding by encoding the training text-based prompt of the training data object;
generating the training vector for the training data object by concatenating the text document embedding with the user attribute dataset of the training data object; and
training the machine learned model based on the training vector and the ground truth label of the training data object.

14. The system of claim 13, wherein the one or more processors further perform operations comprising:
initiating, via a user interface of a user computing device, a rendering of a visualization associated with the training text-based prompt; and
generating the ground truth label based on a user interaction with respect to the visualization associated with the training text-based prompt.

15. The system of claim 13, wherein generating the training vector comprises:
determining a metadata feature set associated with one or more script branch instruction sets of the training text-based prompt; and
mapping the text document embedding to the user attribute dataset based on the metadata feature set.

16. The system of claim 13, wherein generating the training vector comprises:
determining a sentiment classification for the training text-based prompt; and
mapping the text document embedding to the user attribute dataset based on the sentiment classification.

17. The system of claim 12, wherein the machine learned model is trained using back propagation of errors.

18. The system of claim 12, wherein the one or more processors further perform operations comprising:
generating, using the text encoder model, the input text document embedding by encoding an input text-based prompt of the input user-text pair.

19. The system of claim 12, wherein the training text-based prompt comprises a first branching script that is generated before the machine learned model is trained and the input text-based prompt comprises a second branching script that is generated after the machine learned model is trained.

20. One or more non-transitory computer-readable media storing processor-executable instructions that, when executed by one or more processors, cause the one or more processors to perform operations comprising:
receiving a user attribute feature set associated with a user identifier for a user-text pair;
generating an input text document embedding for the user identifier;
generating an input vector by concatenating the user attribute feature set with the input text document embedding;
generating, using a machine learned model that is trained based on a ground truth label and a training vector associated with a text document embedding generated by a text encoder model, a classification score for the input text document embedding based on the input vector; and
upon determining that the classification score satisfies a predetermined threshold, generating a transcript corresponding to the input text document embedding.
